(19) United States
(12) Patent Application Publication
(10) Pub. No.: US 2006/0235613 A1
(43) Pub. Date: Oct. 19, 2006

(54) INTEGRAL NAVIGATION AND AUDIO/VIDEO SYSTEM WITH FUNCTION OF PREVENTING INTERRUPTION OF AUDIO SIGNAL, AND CONTROL METHOD THEREOF

(76) Inventor: JAE KYOU YOON, Icheon-shi, Kyungki-do (KR)

Correspondence Address: IPLA P.A., 3580 WILSHIRE BLVD., 17TH FLOOR, LOS ANGELES, CA, 90010, US

(21) Appl. No.: 11/308,041

(22) Filed: Mar. 3, 2006

(30) Foreign Application Priority Data
Apr. 15, 2005 (KR) 10-2005-0031270

(51) Int. Cl. G01C 21/34

(52) U.S. Cl. 701/213; 701/211; 340/995.28

(57) ABSTRACT

An integral navigation and A/V system for preventing an audio signal from being interrupted due to a voice guidance of a navigation system, and a control method thereof are provided. The system includes: a navigation module having geographical information, and measuring a self position, mapping the measured self position to the geographical information, setting a path to an inputted destination, mapping the set path to the geographical information, and outputting a position based guidance voice; an audio processor for receiving and distributing the audio signal to corresponding channels, outputting the distributed audio signal, and receiving and outputting the guidance voice to the speaker corresponding to the channel; and a controller for controlling the audio processor to distribute the audio signal and the guidance voice by channels.

### BACKGROUND OF THE INVENTION

1. Field of the Invention

The present invention relates to a navigation system combined with an audio/video (A/V) system, and more particularly, to an integral navigation and A/V system for preventing an audio signal from being interrupted due to a voice guidance of a navigation system, and a control method thereof.

2. Description of the Related Art

As the number of cars in use is currently increased by one car per a household and the car gets to be living necessaries, drivers spend a lot of times in the car. As the time spent in the car is increased, an audio system is installed at the car.

In recent years, the driver is paying much attention to and tends to much install an audio/video system (Hereinafter, referred to as “A/V system”) being a combination of the audio system and a video system that allows the drivers to appreciate a movie or a television. Together with this, the driver is paying much attention to and tends to much install a navigation and telematics system for performing road guidance to a destination on the basis of a global positioning system (GPS) measuring a self position. Further, as the A/V system and the navigation system are increasingly installed, they are being put on the market in a combined form.

As the A/V system and the navigation system are of a combined form, an audio signal outputted from the A/V system and a guidance voice signal outputted from the navigation system are interfered. In general, in order to improve this defect, while the audio signal is outputted, upon generation of the guidance voice of the navigation system, the audio signal is cut off and the guidance voice is outputted, and upon completion of the outputting of the guidance voice, the audio signal is again outputted through a speaker.

As described above, in the conventional integral navigation and A/V system, the audio signal is temporarily interrupted and the guidance voice is outputted and therefore, there is a drawback in that passengers listening to audio can be annoyed.

### SUMMARY OF THE INVENTION

Accordingly, the present invention is directed to an integral navigation and A/V system and a control method thereof that substantially overcome one or more of the limitations and disadvantages of the conventional art.

One object of the present invention is to provide an integral navigation and A/V system for preventing an audio signal from being interrupted due to a voice guidance of a navigation system, and a control method thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided an integral navigation and audio/video system with a function of preventing interruption of an audio signal, the system including: a navigation module having geographical information, and measuring a self position through a GPS (global positioning system), mapping the measured self position to the geographical information, setting a path to an inputted destination, mapping the set path to the geographical information, and outputting a position based guidance voice to perform road guidance along the path; an audio processor for receiving and distributing the audio signal to corresponding channels, outputting the distributed audio signal through a speaker corresponding to the channel, and receiving and outputting the guidance voice under a predetermined control to the speaker corresponding to the channel to which the audio signal is distributed; and a controller for controlling the audio processor to distribute the audio signal and the guidance voice by channels.

In another aspect of the present invention, there is provided an integral navigation and A/V (audio/video) system with a function of preventing interruption of an audio signal, the system including: a navigation module having geographical information, and measuring a self position through a GPS (global positioning system), mapping the measured self position to the geographical information, setting a path to an inputted destination, mapping the set path to the geographical information, and outputting a position based guidance voice to perform road guidance along the path; an audio distributor for, under a predetermined control, receiving an audio signal and distributing the received audio signal as a first audio signal and a second audio signal and, upon receipt of the guidance voice, cutting off the second audio signal, and separating and outputting the guidance voice; a first audio processor for receiving and distributing the first audio signal to a corresponding channel, and outputting the distributed first audio signal through a speaker corresponding to the channel; a second audio processor for receiving and distributing the second audio signal or the guidance voice to a corresponding channel, and outputting the distributed second audio signal or guidance voice through a speaker corresponding to the channel; and a controller for controlling the audio distributor to distribute the audio signal and the guidance voice to the first and second audio processors.

In a further another aspect of the present invention, there is provided a method for preventing interruption of an audio signal in an integral navigation and A/V (audio/video) system that is in course of outputting the audio signal and performs road guidance in a navigation mode, the method including the steps of: determining whether or not to receive a guidance voice depending on the road guidance; upon receipt of the guidance voice, distributing and outputting the audio signal and the guidance voice to channels; and upon completion of the outputting of the guidance voice, setting an audio signal-only mode, and allocating and outputting the audio signal to the channels.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 is a block diagram illustrating a construction of an integral navigation and A/V system with a function of preventing interruption of an audio signal according to the first embodiment of the present invention;

FIG. 2 is a block diagram illustrating a construction of an integral navigation and A/V system with a function of preventing interruption of an audio signal according to the second embodiment of the present invention; and

FIG. 3 is a flowchart illustrating a method for preventing interruption of an audio signal in an integral navigation and A/V system according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

In the present invention, while an audio signal is outputted, upon generation of a guidance voice of a navigation system, the guidance voice and the audio signal are separated, and speakers are allocated to concurrently output the guidance voice and the audio signal. The guidance voice is outputted through the speaker adjacent to a driver, and the audio signal is outputted through the speaker adjacent to a passenger other than the driver. For example, a front speaker outputs the guidance voice and a rear speaker outputs the audio signal, or only a driver-side speaker outputs the guidance voice and other speakers output the audio signal.

Hereinafter, a description will be made with reference to the drawings.

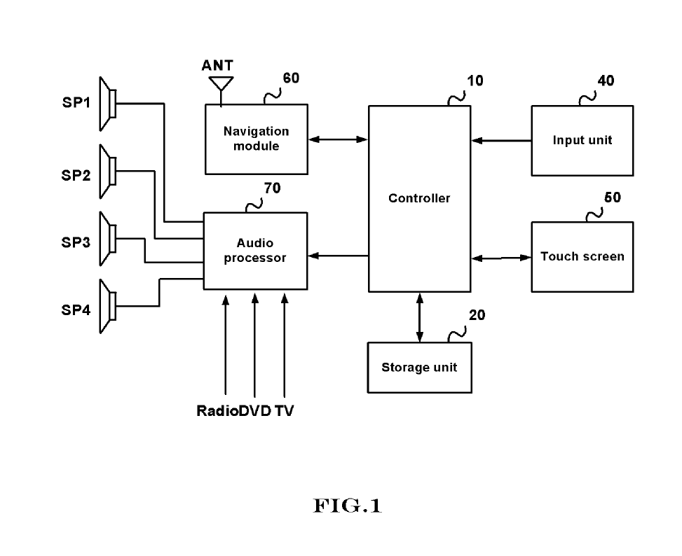

FIG. 1 is a block diagram illustrating a construction of an integral navigation and audio/video (A/V) system with a function of preventing interruption of the audio signal according to the first embodiment of the present invention.

Referring to FIG. 1, the inventive integral navigation and A/V system includes a controller 10, a storage unit 20, an input unit 40, a touch screen 50, a navigation module 60, an audio processor 70, and a plurality of speakers (SP1, SP2, SP3, and SP4).

The controller 10 controls a general operation of the inventive integral navigation and A/V system.

The storage unit includes a region for storing a control program for preventing the interruption of the audio signal, and a region for temporarily storing data generated in execution of the control program.

The input unit 40 includes a plurality keys for controlling an A/V system and a navigation system, and generates key data on the keys and outputs the generated data to the controller 10.

The touch screen 50 includes a display device such as a liquid crystal display (LCD) for receiving and displaying image data in a television mode, and receiving and displaying geographical data in a navigation mode; and a touch pad provided integrally with the display device, and generating and outputting a coordinate value of its pressed point to the controller 10.

The navigation module 60 has geographical information and guidance voice data for road guidance. The navigation module 60 receives each position signal from a plurality of GPS satellites to calculate a self position, maps a path from the calculated position to a destination inputted on the basis of the geographical information by the driver to the geographical information, outputs the mapped path to the controller 10 and, if the calculated position is a position where the voice guidance should be performed, outputs the corresponding voice data to the controller 10.

Under the control of the controller 10, the audio processor 70 receives the guidance voice and the audio signal from a radio (not shown), a digital video disk (DVD) player (not shown), and a television (not shown), and outputs the received guidance voice and audio signal through the speaker. In the first embodiment of the present invention, under the control of the controller 10, the audio processor 70 separates and allocates the received guidance voice and audio signal by channels, and outputs the allocated guidance voice and audio signal through the corresponding speaker.

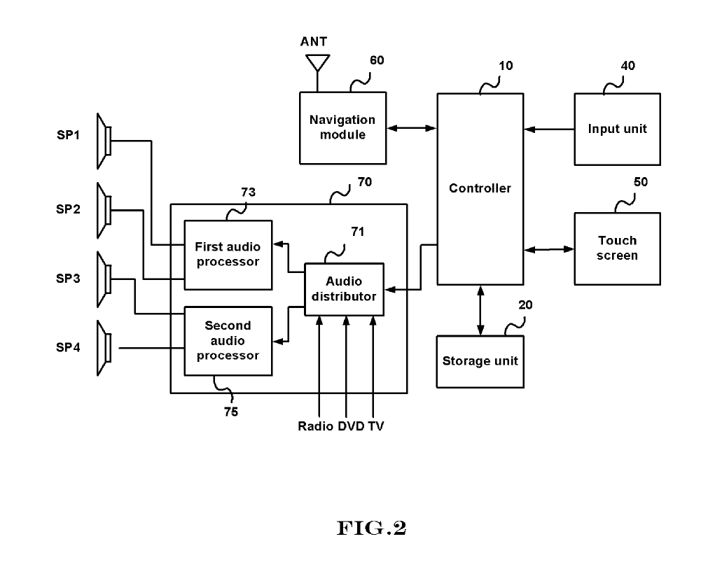

FIG. 2 is a block diagram illustrating a construction of an integral navigation and A/V system with a function of preventing interruption of an audio signal according to the second embodiment of the present invention.

In the second embodiment of the present invention, the channel is not allocated as in the first embodiment of the present invention, and an audio processor 70 includes an audio distributor 71 for distributing a guidance voice and the audio signal, a first audio processor 73 for processing the guidance voice, and a second audio processor 75 for processing the audio signal, and concurrently outputs the guidance voice and the audio signal.

The first audio processor 73 is connected with a speaker (SP1) and a speaker (SP2), and the second audio processor 75 is connected with a speaker (SP3) and a speaker (SP4). Further, a switch unit (not shown) can be also provided between the speakers (SP1 and SP2, and SP3 and SP4) and the first and second audio processors 73 and 75, and switches connection between the first and second audio processors 73 and 75 and the speakers (SP1 and SP2, and SP3 and SP4) under the control of the controller 10. In case where the switch unit is provided, a driver can select the speaker outputting the guidance voice and the speaker outputting the audio signal, through the input unit 40.

In detail, upon receipt of the guidance voice from the navigation module 60, the controller 10 controls the audio distributor 71 to output the audio signal received from the radio, the DVD player, and the TV, to the first and second audio processors 73 and 75, and the first and second audio processor 73 and 75 output the audio signals through the connected speakers, respectively. On the contrary, upon receipt of the guidance voice from the navigation module 60, the controller 10 controls the audio distributor 71 to output the guidance voice to the first audio processor 73 and output the audio signal to the second audio processor 75.

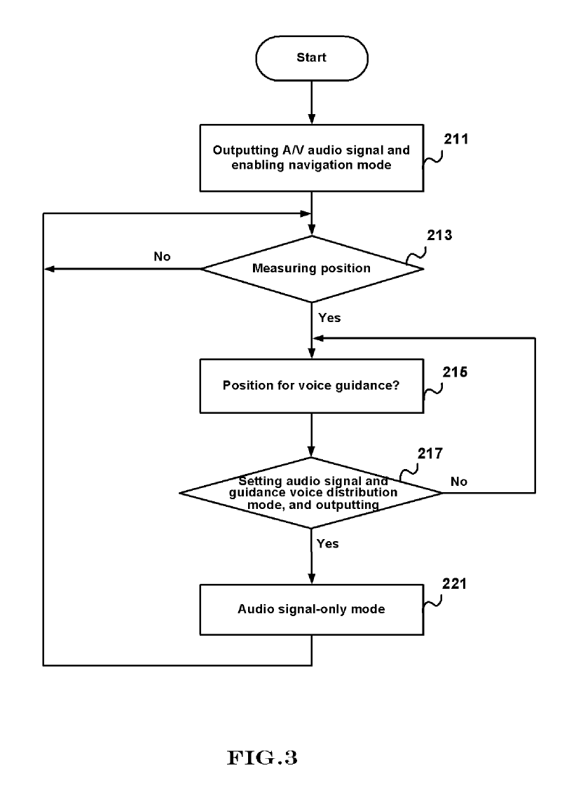

FIG. 3 is a flowchart illustrating a method for preventing interruption of the audio signal in the integral navigation and A/V system according to the present invention. Hereinafter, a description will be made with reference to FIGS. 1 to 3.

The present invention is applied only to a case where audio and navigation modes are concurrently performed.

First, when the A/V audio signal is in course of being outputted and the navigation mode is enabled in Step 211, the controller 10 determines whether or not to receive the guidance voice from the navigation module 60 in Step 213. If it is determined to receive the guidance voice from the navigation module 60 in the Step 213, in Step 215, the controller 10 controls the audio processor 70 of FIG. 1 to allocate the audio signal and the guidance voice by channels, and output the audio signal and the guidance voice through the corresponding speaker. In the second embodiment of the present invention, the controller 10 controls the audio distributor 71 to cut off the audio signal from being outputted to the first audio processor 73, and output the guidance voice to the corresponding speaker through the first audio processor 73.

When the guidance voice and the audio signal are distributed and outputted, the controller 10 determines whether or not voice guidance is terminated in Step 217. If it is determined to terminate the voice guidance in the Step 217, the controller 10 sets an audio signal-only mode in Step 221, and controls the audio processor 70 of FIG. 1 to allocate all channels to the audio signal and output the audio signal through the corresponding speaker. In the second embodiment of the present invention, the controller 10 controls the audio distributor 71 to again output the audio signal cut off in the Step 215 to the corresponding speaker through the first audio processor 73.

As described above, the present invention has an advantage in that since the guidance voice and the audio signal are distributed and outputted, even when the guidance voice is generated, the audio signal can be outputted without interruption, thereby improving car passenger's satisfaction without annoyance.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. An integral navigation and audio/video system with a function of preventing interruption of an audio signal, the system comprising:
a navigation module having geographical information, and measuring a self position through a GPS (global positioning system), mapping the measured self position to the geographical information, setting a path to an inputted destination, mapping the set path to the geographical information, and outputting a position based guidance voice to perform road guidance along the path;
an audio processor for receiving and distributing the audio signal to corresponding channels, outputting the distributed audio signal through a speaker corresponding to the channel, and receiving and outputting the guidance voice under a predetermined control to the speaker corresponding to the channel to which the audio signal is distributed; and
a controller for controlling the audio processor to distribute the audio signal and the guidance voice by channels.

2. The system according to claim 1, wherein in distribution to the channel, the guidance voice is distributed to a channel corresponding to a speaker installed at a front car seat.

3. The system according to claim 1, wherein in distribution to the channel, the guidance voice is distributed to a channel corresponding to a speaker installed at a driver seat.

4. An integral navigation and A/V (audio/video) system with a function of preventing interruption of an audio signal, the system comprising:
a navigation module having geographical information, and measuring a self position through a GPS (global positioning system), mapping the measured self position to the geographical information, setting a path to an inputted destination, mapping the set path to the geographical information, and outputting a position based guidance voice to perform road guidance along the path;
an audio distributor for, under a predetermined control, receiving an audio signal and distributing the received audio signal as a first audio signal and a second audio signal and, upon receipt of the guidance voice, cutting off the second audio signal, and separating and outputting the guidance voice;
a first audio processor for receiving and distributing the first audio signal to a corresponding channel, and outputting the distributed first audio signal through a speaker corresponding to the channel;
a second audio processor for receiving and distributing the second audio signal or the guidance voice to a corresponding channel, and outputting the distributed second audio signal or guidance voice through a speaker corresponding to the channel; and
a controller for controlling the audio distributor to distribute the audio signal and the guidance voice to the first and second audio processors.

5. The system according to claim 4, further comprising a switch unit connected between the speakers and the first and second processors, and switching and outputting the audio signal and the guidance voice, by channels, from the first and second audio processors to the speakers under the control of the controller.

6. A method for preventing interruption of an audio signal in an integral navigation and A/V (audio/video) system that is in course of outputting the audio signal and performs road guidance in a navigation mode, the method comprising the steps of:
determining whether or not to receive a guidance voice depending on the road guidance;
upon receipt of the guidance voice, distributing and outputting the audio signal and the guidance voice to channels; and
upon completion of the outputting of the guidance voice, setting an audio signal-only mode, and allocating and outputting the audio signal to the channels.
